(19) United States
(12) Patent Application Publication
(10) Pub. No.: US 2021/0162244 A1
(43) Pub. Date: Jun. 3, 2021

(54) DUSTPROOF MASK AND MANUFACTURING METHOD THEREOF

(71) Applicant: Dae Soo JANG, Namyangju-si, Gyeonggi-do (KR)

(72) Inventor: Dae Soo JANG, Namyangju-si, Gyeonggi-do (KR)

(21) Appl. No.: 17/047,190

(22) PCT Filed: Apr. 12, 2019
(86) PCT No.: PCT/KR2019/004421

§ 371 Date: Oct. 13, 2020

(30) Foreign Application Priority Data
Apr. 13, 2018 (KR) 10-2018-0043224
Mar. 21, 2019 (KR) 10-2019-0032522

(51) Int. Cl. A62B 23/02; A41D 13/11; B01D 46/10; B01D 46/00; B01D 46/42; B01D 39/08; A62B 7/10; A62B 9/02; A62B 18/08; A62B 18/10

(52) U.S. Cl. CPC A62B 23/025; B01D 2265/04; B01D 46/103; B01D 46/0023; B01D 46/4272; B01D 46/0005; B01D 46/0001; B01D 39/08; A62B 7/10; A62B 9/02; A62B 18/084; A62B 18/10; A41D 13/1161; B01D 2239/0618; B01D 2239/10; A41D 13/1138

(57) ABSTRACT

A dustproof mask includes a mask body which is adapted to cover a user's face and forms a breathing space between an inner surface thereof and the user's face, wherein breathing of a user's respiratory system is performed through the breathing space, an air filter part disposed in front of the mask body, coupled to one side of an outer surface of the mask body, configured to be filled with external air which passes through an outer surface thereof formed of a filter material and contaminants therein are removed, and having a sealed pouch shape, and an intake valve part installed in a coupled portion of the mask body and the air filter part and operated to supply the air inside the air filter part to the breathing space during inhalation.

### TECHNICAL FIELD

The present invention relates to a dustproof mask and a method of manufacturing the same, and more specifically, to a dustproof mask including a mask body of which an edge is brought into close contact with a user's face and an air filter part which is provided separately, is detachably coupled to an outer side of the mask body, is filled with purified external air, and has a sealed pouch shape, thereby allowing the purified external air to be supplied to a user during inhalation and allowing air generated during exhalation to be discharged to the outside so that inhalation of contaminants contained in external air is prevented and uncomfortable breathing due to mask wearing is minimized, and a method of manufacturing the same.

### BACKGROUND ART

Masks according to the conventional art have a structure covering a user's face using a contaminant filtration cloth, however, since the filtration cloth of the mask is brought into close contact with a respiratory part such as a user's mouth or nose, there are disadvantages in that breathing is uncomfortable and contaminants easily penetrate the filtration cloth.

Accordingly, in order to solve such problems of the conventional art, a dustproof mask having a structure similar to that of a gas mask, in which a dustproof filter is installed around a front or side surface of the mask so that a user inhales only air filtered by the dustproof filter, has been recently developed as described in Document 1.

However, in the case of the dustproof mask, since a shape is similar to that of the gas mask in addition to the complex structure and a high price, when a general user or industrial worker wears the dustproof mask, activity is excessively restricted, and thus there is a problem of greatly lowering practicality.

### DOCUMENT 1

Korean Utility Model No. 2009-0010452 (Publication Date: Oct. 14, 2009)

### TECHNICAL PROBLEM

The present invention is directed to providing a dustproof mask including a mask body of which an edge is brought into close contact with a user's face and an air filter part which is provided separately, is detachably coupled to an outer side of the mask body, is filled with purified external air, and has a sealed pouch shape, thereby allowing the purified external air to be supplied to a user during inhalation, and allowing air generated during exhalation to be discharged to the outside so that inhalation of contaminants contained in external air is prevented even with a simple structure, mixing of inhaled air and exhaled air is minimized and uncomfortable breathing due to mask wearing is significantly reduced, and a method of manufacturing the same.

The present invention is also directed to providing the dustproof mask in which the air filter part is installed to be spaced apart from an outer surface of the mask body by a predetermined distance so that external air is introduced into the air filter part through an air passage formed by a separation space between the air filter part and the mask body in addition to passing through the front of the air filter part so that an area through which external air is introduced into the air filter part is significantly increased so as to further reduce uncomfortable breathing of the user, and a method of manufacturing the same.

### Technical Solution

One aspect of the present invention provides a dustproof mask including a mask body which is adapted to cover a user's face and forms a breathing space between an inner surface thereof and the user's face, wherein breathing of a user's respiratory system is performed through the breathing space, an air filter part disposed in front of the mask body, coupled to one side of an outer surface of the mask body, configured to be filled with external air which passes through an outer surface thereof formed of a filter material and contaminants therein are removed, and having a sealed pouch shape, an intake valve part installed in a coupled portion of the mask body and the air filter part and operated to supply the air inside the air filter part to the breathing space during inhalation, and an exhaust valve part installed on the other side of the outer surface of the mask body and operated to discharge air inside the breathing space to the outside during exhalation, wherein the air filter part is coupled to be spaced apart from the outer surface of the mask body so that an air passage through which external air flows is formed between the air filter part and the mask body.

Another aspect of the present invention provides a method of manufacturing the dustproof mask, the method including (a) forming an air filter part having a sealed pouch shape, (b) forming a mask body having a dome shape in which an intake hole and an exhaust hole formed in an outer surface thereof are coupled to an intake valve part and an exhaust valve part, respectively, and (c) coupling the air filter part disposed in front of the mask body to the outer surface of the mask body, wherein the step (a) includes (a1) forming a first filter member having a dome shape, (a2) forming a second filter member in which a through hole is formed in an central portion thereof and which has a dome shape, and (a3) bonding edge portions of the first filter member and the second filter member to form a sealed pouch shape in which a space filled with external air introduced through the first filter member and the second filter member is formed.

Still another aspect of the present invention provides a method of manufacturing a dustproof mask including a mask body brought into close contact with a user's face and an air filter part detachably coupled to an outer side of the mask body and having a pouch shape, the method including (a) preparing a filter member having a sheet shape, (b) forming an intake hole at one side of the filter member, (c) dividing the filter member into a first region in which the intake hole is formed and a second region which is the remaining region and folding the filter member such that a length of the second region is greater than a length of the first region, and (d) bonding edge portions, where outer end portions of the first region and the second region are in contact with each other, to form a space having a pouch shape therein so that the air filter part is manufactured.

### Advantageous Effects

As described above, in a dustproof mask and a method of manufacturing the same according to the present invention, since a mask body of which an edge is brought into close contact with a user's face and an air filter part which is detachably coupled to an outer side of the mask body, is filled with purified external air, and has a sealed pouch shape are separately provided to allow the purified air to be supplied to a user during inhalation and allow air generated during exhalation to be discharged, there is an advantage of preventing inhalation of external contaminants during breathing even using the dustproof mask with a simple structure.

In addition, in the dustproof mask and the method of manufacturing the same according to the present invention, since mixing of inhaled air and exhaled air is minimized in a breathing space, which is a sealed space between the mask body and the user's face, due to the above-described structure, and a method of inhaling the purified air filling the air filter part in advance during inhalation is used, there is an advantage in that uncomfortable breathing due to mask wearing can be further reduced than a mask according to the conventional art which requires inhaling external air through a vent hole of a mask body for every breath.

In addition, in the dustproof mask and the method of manufacturing the same according to the present invention, since the air filter part is installed to be spaced apart from an outer surface of the mask body by a predetermined distance so as to introduce external air into the air filter part through an air passage formed in a separation space between the air filter part and the mask body in addition to passing through the front of the air filter part, an area through which external air is introduced into the air filter part is significantly increased, and thus there is an advantage in that uncomfortable breathing of the user can be further reduced.

### DESCRIPTION OF DRAWINGS

FIG. 1 is a perspective view illustrating an entire structure of a dustproof mask according to a first embodiment of the present invention.

FIG. 2 is a view illustrating a state in which the dustproof mask illustrated in FIG. 1 is worn.

FIG. 3 is a cross-sectional view taken along line A-A of FIG. 2.

FIGS. 4 and 5 are detailed enlarged views illustrating a portion A and a portion B of FIG. 3, respectively.

FIG. 6 is a set of views illustrating an operation state of the dustproof mask illustrated in FIG. 1.

FIG. 7 is a process flowchart for describing a method of manufacturing the dustproof mask illustrated in FIG. 1.

FIG. 8 is a set of views for describing a method of manufacturing an air filter part of FIG. 1 according to a second embodiment of the present invention.

FIGS. 9 and 10 are a set of views for describing a method of manufacturing an air filter part of FIG. 1 according to a third embodiment of the present invention and a set of cross-sectional views taken along line B-B of FIG. 9 for describing a use state, respectively.

FIGS. 11 and 12 are a set of views for describing a method of manufacturing an air filter part of FIG. 1 according to a fourth embodiment of the present invention and a set of cross-sectional views taken along line C-C of FIG. 11 for describing a use state, respectively.

FIG. 13 is a perspective view illustrating a structure of a dustproof mask according to a fifth embodiment of the present invention.

FIG. 14 is a view illustrating a state in which the dustproof mask illustrated in FIG. 13 is worn.

FIG. 15 is a cross-sectional view taken along line D-D of FIG. 14.

FIG. 16 is a set of views for describing a method of manufacturing the dustproof mask according to the fifth embodiment of the present invention.

### MODES OF THE INVENTION

Hereinafter, exemplary embodiments of the present invention will be specifically described with reference to the accompanying drawings.

### First Embodiment

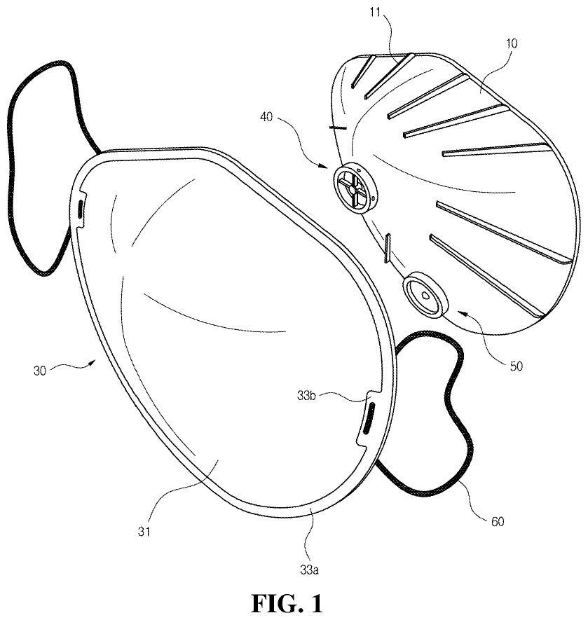

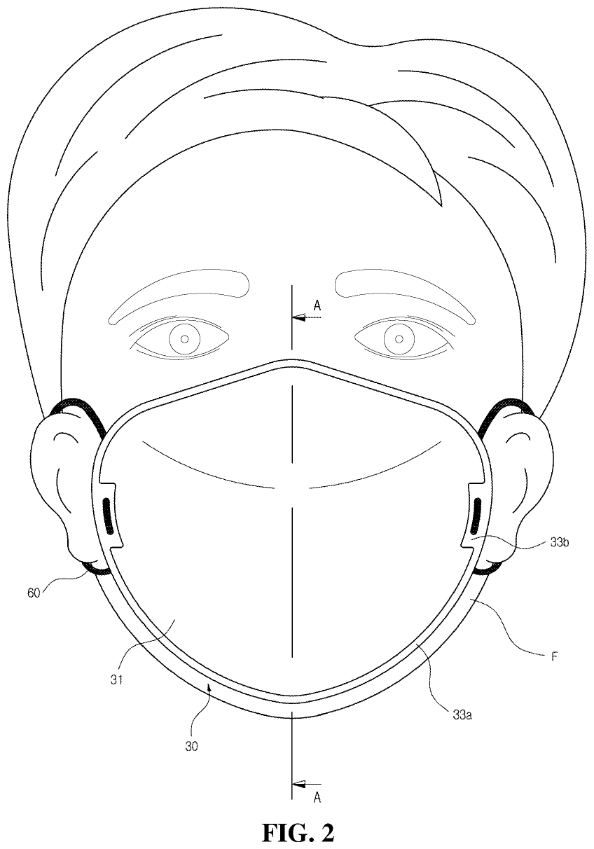

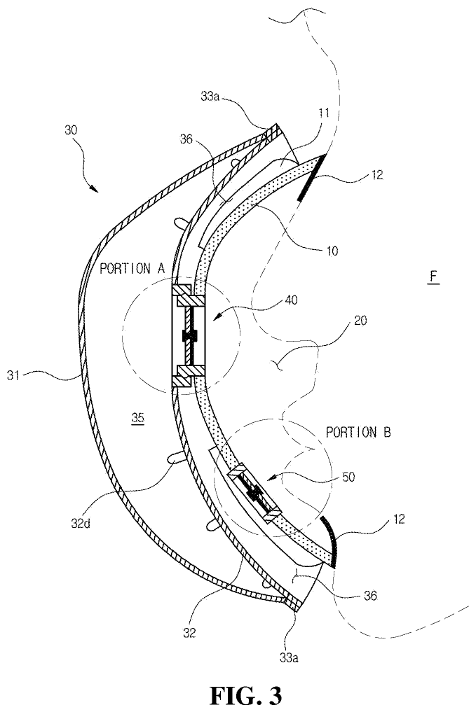

As illustrated in FIGS. 1 to 3, a dustproof mask according to the present invention is formed to include a mask body 10 which is adapted to cover a user's face F and forms a breathing space 20 between an inner surface thereof and the user's face F, an air filter part 30 disposed in front of the mask body 10 and coupled to one side of an outer surface of the mask body 10, and air guide members 40 and 50 operated to supply air inside the air filter part 30 to the breathing space 20 during inhalation and discharge air inside the breathing space 20 to the outside during exhalation.

In this case, the mask body 10, similar to a general mask, performs a function of preventing contaminants such as yellow dust, particles, and motes contained in external air from being directly introduced into a user's respiratory system, and may be made of a cloth material, such as cotton or a non-woven fabric, or a synthetic resin material such as silicone or polyester.

In addition, an edge portion of the mask body 10 may also be formed of a shape memory material capable of maintaining a changed shape along a curve of the user's face F so as to be easily brought into close contact with the user's face F.

In addition, the mask body 10 according to the present invention may be made of an impermeable material such as a synthetic resin to introduce external air filling the air filter part 30 in a state in which contaminants are removed into the breathing space 20 during inhalation as will be described below, and in a case in which the mask body 10 is formed of a cloth material such as a non-woven fabric, the outer surface of the mask body 10 may be coated with an impermeable material such as silicone.

In addition, the edge portion of the mask body 10 may further include a close-contact member 12 for closer contact with the user's face F, and due to the above-described structure, the breathing space 20 in which breathing is performed in the mask body 10 by the user's respiratory system may be formed as a sealed space separated from the outside (that is the outside of the mask body).

Meanwhile, the air filter part 30 is disposed in front of the mask body 10, coupled to one side of the outer surface of the mask body 10, and formed such that external air fills an inner space 35 through the outer surface thereof exposed to the outside.

To this end, the outer surface of the air filter part 30 is formed of a filter material capable of filtering the contaminants contained in external air, and the external air in a state, in which the contaminants are removed after passing through the outer surface of the air filter part 30, fills the inner space 35 of the air filter part 30.

In addition, the air filter part 30 is detachably coupled to one side of the outer surface of the mask body 10 through the described-below method, and a rear surface thereof facing the mask body 10 is installed to be spaced apart from the outer surface of the mask body 10 by a predetermined distance so that an air passage 36 through which external air flows is formed between the air filter part 30 and the mask body 10.

In this case, a plurality of spacers 11 having rib shapes to maintain the predetermined separation distance from the air filter part 30 may be formed on the outer surface of the mask body 10.

Due to the above-described structure, in the dustproof mask according to the present invention, since the air filter part 30 is installed to be spaced apart from the outer surface of the mask body 10 by the predetermined distance so that external air is introduced into the air filter part 30 through the air passage 36 formed by the separation space between the air filter part 30 and the mask body 10 in addition to passing though the front of the air filter part 30, an area through which the external air is introduced into the air filter part 30 is significantly increased.

Accordingly, in the dustproof mask according to the present invention, since the area through which external air is introduced is increased, external air may easily fill the inner space 35 of the air filter part 30, and thus there is an advantage in that uncomfortable breathing of the user due to mask wearing can be reduced when compared to a mask according to the conventional art.

In this case, the air filter part 30 may be formed to have any shape as long as it performs the same function but may be more preferably formed to have a shape corresponding to a shape of the outer surface of the mask body 10.

As an example of the present embodiment, the outer surface of the mask body 10 is formed to have a convex dome shape in a forward direction of the user's face F, and a front surface, which is exposed to the outside, and the rear surface, which faces the outer surface of the mask body 10, of the air filter part 30 are formed to have convex dome shapes in the forward direction of the user's face F, but curvatures of the front surface and the rear surface of the air filter part 30 may be formed to be different so as to secure the inner space 35 of the air filter part 30.

In addition, the air filter part 30 may be formed of a single member having a pouch shape but, as an example of the present embodiment, the air filter part 30 is formed to include a first filter member 31 disposed in front of the mask body 10 and a second filter member 32 disposed between the mask body 10 and the first filter member 31.

In this case, an edge portion of the first filter member 31 and an edge portion of the second filter member 32 are bonded to form first bonded portions 33a so that a sealed pouch shape is formed, and the first and second filter members 31 and 32 may be bonded using a thermal bonding method, an ultrasonic welding method, or a method using an adhesive.

According to the above-described structure, the first filter member 31 removes contaminants contained in external air introduced through the front of the air filter part 30, and the second filter member 32 removes contaminants contained in external air introduced through the air passage 36.

In addition, a plurality of separating protrusions 32d may be formed to protrude from an inner surface of the second filter member 32 to prevent the inner space 35 filled with external air from contracting by inner surfaces of the first and second filter members 31 and 32 coming into contact with each other, and the separating protrusions 32d may be formed on the inner surface of the first filter member 31 or both of the inner surfaces of the first and second filter members as necessary.

In addition, unlike the present embodiment, the separating protrusions 32d may also be formed as separate members and interposed between the first filter member 31 and the second filter member 32 as necessary.

In addition, the separating protrusions 32d may be formed of a spring type material or have a shape having an elastic force as necessary so that, after a distance between the first filter member 31 and the second filter member 32 is decreased (that is, after a volume of the inner space is decreased) while air in the inner space 35 is introduced into the breathing space 20 during inhalation, the distance between the first filter member 31 and the second filter member 32 is increased by the elastic restoring force of the separating protrusions 32d, and thus introduction of external air can be further facilitated.

In this case, end portions of the separating protrusions 32d may also be formed to be in contact with the inner surface of the filter member (in the case of the present invention, first filter member) facing the end portions in a state in which the distance between the first filter member 31 and the second filter member 32 is not decreased (that is, a normal state in which inhalation is not performed).

In addition, in the case of the first filter member 31 and the second filter member 32, the first filter member 31 and the second filter member 32 are formed of an elastic material or have a shape having an elastic force so that, after the first filter member 31 and the second filter member 32 are deformed in directions in which the volume of the inner space 35 is decreased by inhalation, the shapes thereof are restored by the elastic restoring force thereof to increase the volume of the inner space 35, and thus introduction of external air can be further facilitated.

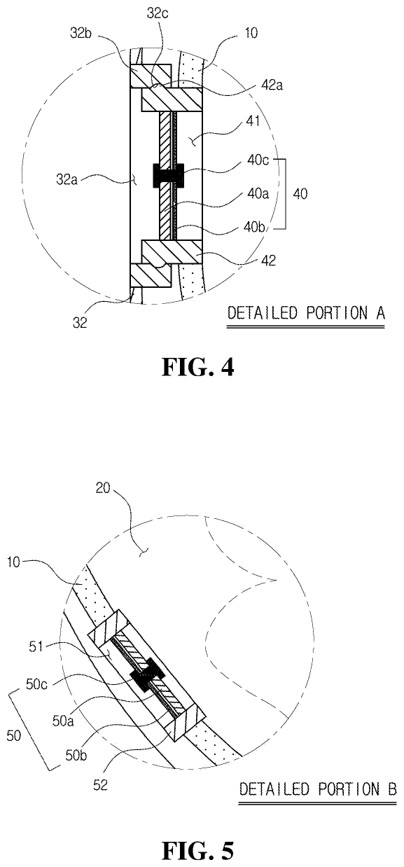

In addition, in order to couple the air filter part 30 and the mask body 10 and to supply air filling the inner space 35 of the air filter part 30 to the breathing space 20 during inhalation as will be described below, a first intake hole 32a communicating with the inner space 35 of the air filter part 30 and a first coupling member 32b having a tubular shape and protruding outward from an edge of the first intake hole 32a are formed in a central portion of the second filter member 32 as illustrated in FIG. 4.

In this case, a coupling groove 32c may be formed in an inner circumferential surface of the first coupling member 32b to be coupled to the mask body 10 as will be described below.

In addition, the first coupling member 32b may be firmly coupled to the edge portion of the first intake hole 32a using a thermal bonding method, an ultrasonic welding method, or a method using an adhesive, but may be coupled thereto in a detachable manner so as to be replaceable as necessary.

In addition, second bonded portions 33b where the first filter member 31 and the second filter member 32 are partially bonded may be formed in end portions of both sides of the air filter part 30 to be coupled to wearing straps 60, and as an example of the present embodiment, the second bonded portions 33b are formed to be connected to the first bonded portions 33a at the end portions of both sides of the air filter part 30.

In this case, the wearing straps 60 may be formed as straps or bands hooked and worn on both ears or a head of the user, and as an example of the present embodiment, the wearing straps 60 are formed to be hooked and worn on both ears of the user.

As described above, in a case in which the user wears the dustproof mask using the wearing straps 60, an edge of the mask body 10 is brought into close contact with the user's face F by the close-contact member 12, and an edge (that is, in the case of the present invention, first bonded portion) of the air filter part 30 is spaced apart from the user's face F so that the air passage 36 can be maintained.

Meanwhile, the air guide members 40 and 50 include the intake valve part 40 that guides or blocks external air filling the inner space 35 of the air filter part 30 to or from the breathing space 20 and the exhaust valve part 50 that guides or blocks air inside the breathing space 20 to or from the outside.

In order to install the intake valve part 40 and the exhaust valve part 50, a second intake hole 41 communicating with the breathing space 20 and a second coupling member 42 protruding from an edge of the second intake hole 41 and having a tubular shape are formed at one side of the outer surface of the mask body 10, and an exhaust hole 51 communicating with the breathing space 20 and an exhaust valve housing member 52 protruding from an edge of the exhaust hole 51 and having a tubular shape are formed at the other side of the outer surface of the mask body 10.

In the case of the present invention, as an example, the second intake hole 41 is formed in a central portion of the mask body 10 at a position corresponding to the first intake hole 32a, and the exhaust hole 51 is formed in a lower portion of the mask body 10.

In this case, a coupling protrusion 42a having a shape corresponding to the coupling groove 32c is formed on an outer circumferential surface of the second coupling member 42, and the first and second coupling members 32b and 42 are coupled by coupling of the coupling groove 32c and the coupling protrusion 42a so that the air filter part 30 is detachably coupled to the mask body 10.

In this case, the coupling groove 32c and the coupling protrusion 42a may be formed to have annular shapes and may be formed to have a plurality of groove-protrusion structures spaced apart from each other as necessary.

Due to the above-described structure, external air filling the inner space 35 of the air filter part 30 is introduced into the breathing space 20 through a coupled portion of the first and second coupling members 32b and 42 formed to have the tubular shapes.

In this case, the intake valve part 40 is installed in a coupled portion of the mask body 10 and the air filter part 30, that is, the coupled portion of the first and the second coupling members 32b and 42 and is operated to allow air inside the air filter part 30 to be supplied to the breathing space 20 during inhalation, and as an example of the present embodiment, the intake valve part 40 is formed to be installed between two ends of the second coupling member 42 but may also be installed between two ends of the first coupling member 32b as necessary.

In the case of the present invention, the intake valve part 40 is formed to include an intake valve sheet 40a formed between two ends of the second coupling member 42 and having a mesh shape, an intake valve 40b seated on the intake valve sheet 40a to be opened during inhalation, and an intake valve fixing member 40c fixing the intake valve 40b to one side of the intake valve sheet 40a.

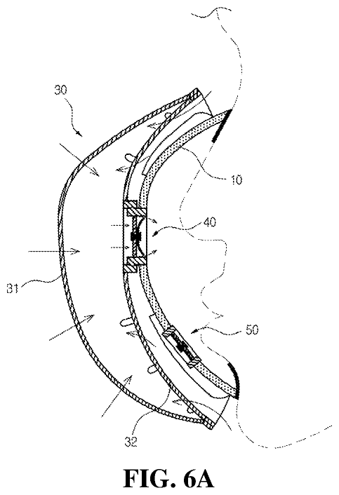

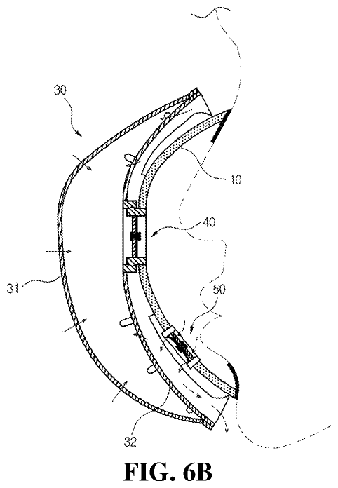

Due to the above-described structure, as illustrated in FIG. 6A, the intake valve 40b is operated to be opened by an inhalation force of the user's respiratory system during inhalation, and as illustrated in FIG. 6B, is operated to be closed by a pressure of air discharged from the user's respiratory system and an elastic force thereof during exhalation.

To this end, the intake valve 40b may be formed of a material or to have a structure having a certain extent of an elastic restoring force like an exhaust valve 50b which will be described below.

In addition, the exhaust valve part 50 is operated to allow air inside the breathing space 20 to be discharged to the outside during exhalation, and to this end, the exhaust valve part 50 is formed to include an exhaust valve sheet 50a formed between two ends of the exhaust valve housing member 52 and having a mesh shape, the exhaust valve 50b seated on the exhaust valve sheet 50a to be opened during exhalation, and an exhaust valve fixing member 50c fixing the exhaust valve 50b to one side of the exhaust valve sheet 50a.

Due to the above-described structure, as illustrated in FIG. 6A, the exhaust valve 50b is closed by an inhalation force of the user's respiratory system and an elastic force thereof during inhalation, and as illustrated in FIG. 6B, is operated to be opened by a pressure of air discharged from the user's respiratory system during exhalation, wherein the exhaled air discharged from the exhaust valve 50b is discharged to the outside through the air passage 36.

As an example of the present embodiment, the intake valve 40b and the exhaust valve 50b are formed as flip valve types of which central portions are fixed to the intake valve sheet 40a and the exhaust valve sheet 50a but may be formed to have any form as long as the same functions are performed.

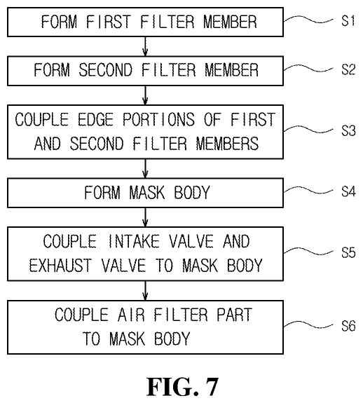

FIG. 7 is a process flowchart for describing a method of manufacturing the dustproof mask illustrated in FIG. 1. In the case of the dustproof mask according to the present invention, the first filter member 31 and the second filter member 32 having dome shapes are formed first (S1 and S2).

In this case, when the first and second filter members 31 and 32 are formed of a filter material such as a non-woven fabric, steps S1 and S2 are performed using a thermoforming method, and in the case of step S2, before and after thermoforming, a process of punching the first intake hole 32a in the second filter member 32 and a process of coupling the edge portion of the first intake hole 32a and the first coupling member 32b using a thermal bonding method and the like are additionally performed.

In addition, when steps S1 and S2 are completed, the edge portions of the first and second filter members 31 and 32 are bonded together to form the first bonded portion 33a so as to form the air filter part 30 having the sealed pouch shape (S3), the bonding of the first and second filter members 31 and 32 may be achieved using a thermal bonding method, an ultrasonic welding method, or a method using an adhesive as described above.

In addition, in step S3, a process of forming the second bonded portions 33b in the end portions of both sides of the air filter part 30 to couple the wearing straps 60 and a process of coupling the second bonded portions 33b and the wearing straps 60 are additionally performed.

Meanwhile, as described above, when steps S1 to S3 are completed, the mask body 10 is formed (S4), and in a case in which the mask body 10 is formed of an impermeable synthetic resin material such as silicone as described above, step S4 may be performed by a general injection process.

In addition, in a case in which the mask body 10 is formed of a cloth material such as a non-woven fabric, after the mask body 10 is formed to have the dome shape by a thermoforming process or the like, a process of coating the outer surface of the mask body 10 with an impermeable material may be additionally performed.

In this case, in step S4, before and after forming the mask body 10, a process of punching the second intake hole 41 and the exhaust hole 51 is additionally performed.

In addition, when step S4 is completed, edge portions of the second intake hole 41 and the exhaust hole 51 are coupled to the second coupling member 42 and the exhaust valve housing member 52, respectively, so that the mask body 10 is coupled to the intake valve part 40 and the exhaust valve part 50 (S5).

In this case, the intake valve part 40 and the exhaust valve part 50 formed to have tubular shapes are installed between two ends of the second coupling member 42 and two ends of the exhaust valve housing member 52, respectively, and more preferably, the second coupling member 42 and the intake valve part 40, and the exhaust valve housing member 52 and the exhaust valve part 50 may be provided as integrated module types to be connectable to the edge portions of the second intake hole 41 and the exhaust hole 51, respectively.

In this case, a process of respectively coupling the edge portions of the second intake hole 41 and the exhaust hole 51 to the second coupling member 42 and the exhaust valve housing member 52 may be preferably performed, for example, by an insert-injection method in the case in which the mask body 10 is formed of the synthetic resin material, or may be preferably performed, for example, by a thermal bonding method, an ultrasonic welding method, or a method using an adhesive in the case in which the mask body 10 is formed of the cloth material such as the non-woven fabric.

In addition, the second coupling member 42 in which the intake valve part 40 is installed and the exhaust valve housing member 52 in which the exhaust valve part 50 is installed may be coupled to the edge portions of the second intake hole 41 and the exhaust hole 51, respectively, to be a detachable structure using an uneveness method, a press-fit method, or the like as necessary.

As described above, when the air filter part 30 and the mask body 10 are completely formed through steps Si to S3 and steps S4 and S5, the first coupling member 32b and the second coupling member 42 are coupled by coupling of the coupling groove 32c and the coupling protrusion 42a so that the air filter part 30 is detachably coupled to the front of the mask body 10.

In addition, as an example of the present embodiment, the case in which the mask body 10 is formed after the air filter part 30 is formed through steps S1 to S3 has been described but the mask body 10 may also be formed first as necessary.

### Second Embodiment

In the case of the present embodiment, an entire structure of a dustproof mask is the same as that of the first embodiment, but, since there is a difference only in a method of manufacturing an air filter part 30, hereinafter, components that are the same as those of the first embodiment will be denoted by the same reference numerals, and redundant descriptions thereof will be omitted.

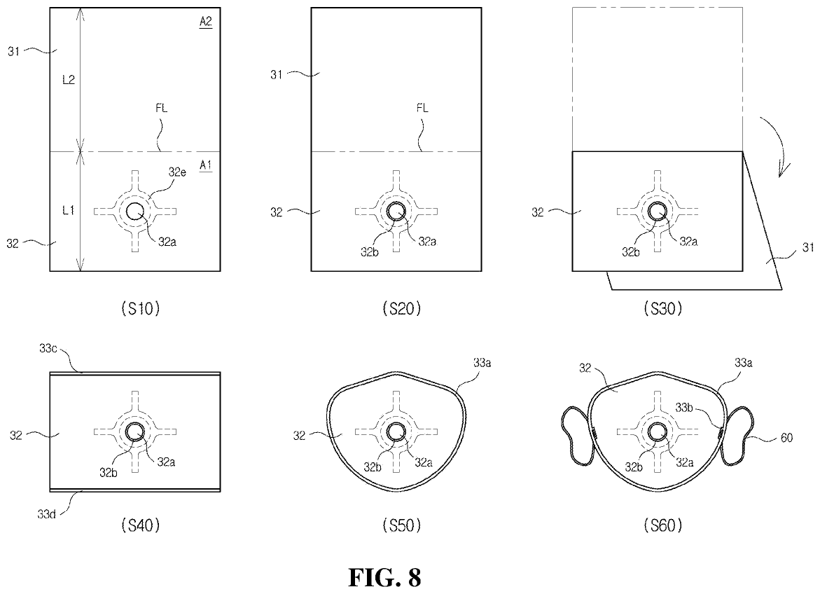

FIG. 8 is a set of views for describing a method of manufacturing an air filter part of FIG. 1 according to a second embodiment of the present invention.

In the method of manufacturing the air filter part 30 according to the second embodiment of the present invention, after the filter members 31 and 32 having sheet shapes are prepared first, the intake hole 32a is formed at one side of the filter members 31 and 32 (S10).

In this case, the filter members 31 and 32 may be divided into a first region A1 in which the intake hole 32a is formed and a second region A2 which is a remaining region by a virtual folding line FL in a longitudinal direction as will be described below, and lengths of the first region A1 and the second region A2 may be different.

To this end, in the present embodiment, as illustrated in FIG. 8, a length L2 of a second region A2 is provided to be greater than a length L1 of a first region A1, and as an example, the length L2 of the second region A2 is provided to be 1.1 to 1.5 times greater than the length L1 of the first region A1.

In this case, a second filter member 32 described in the first embodiment is formed in the first region A1 and a first filter member 31 is formed in the second region A2.

In addition, an intake hole 32a is formed at a position corresponding to an intake valve part 40 of a mask body 10, and as an example of the present embodiment, the intake hole 32a is formed in a central portion of the first region A1.

In addition, step S10 may further include a step of curing a part of an outer side of the intake hole 32a in the first region A1 to form a first support part 32e, and the formation of the first support part 32e may be performed through a method of heating and curing a specific portion of the first region using, for example, a thermoforming or ultrasonic forming method, or a method of bonding a film or the like to the specific portion.

In addition, as described above, in the case of the method of bonding the film or the like to the specific portion, the film may be more preferably formed of a material the same as that of the filter members 31 and 32 or a material having a hardness greater than that of the filter members 31 and 32.

As an example of the case of the present invention, the first support part 32e is formed to have a ring shape provided at an outer side of the intake hole 32a, a bar shape provided above, under, left, and right portions of the intake hole 32a, or a mixed shape thereof.

When step S10 is completed, a step of coupling an edge of the intake hole 32a and a ring-shaped member is performed (S20), the ring-shaped member may be a first coupling member 32b protruding outward from the edge of the intake hole 32a and having a tubular shape as described above.

When step S20 is completed, a step of folding the first region A1 and the second region A2 along a virtual folding line FL is performed (S30), and in this case, the length L2 of the second region A2 is longer than the length L1 of the first region A1 as described above.

In addition, the second filter member 32 and the first filter member 31 previously described in the first embodiment are formed in the first region A1 and the second region A2, respectively, which are folded to face each other, in step S30.

In addition, when step S30 is completed, edge portions where outer end portions of the first region A1 and the second region A2 are in contact with each other are bonded to form a first bonded portion 33a (S40 and S50), and the bonding process may be performed by a thermal bonding method, a ultrasonic bonding method, a method using an adhesive, or the like.

As described above, when the first bonded portion 33a is formed through bonding of the edge portions of the first region (that is, second filter member) and the second region (that is, first filter member), since the length of the second region A2 is greater than the length of the first region A1, the central portion of the second region A2 is formed to have a dome shape which is substantially convex outward.

Accordingly, the first region A1 and the second region A2 may form a pouch-shaped air filter part 30 in which a space is formed.

In this case, the edge portion bonding step may be performed by a single process but may also be performed using a method in which, after the edge portions of the first region A1 and the second region A2 in longitudinal directions (in upward and downward directions of an intake hole in step S40 of FIG. 8) are bonded first, the remaining edge portions are bonded to stably form an inner space of the air filter part 30.

As an example of the present embodiment, the edge portion bonding process is divided into and performed by a first bonding step S40 and a second bonding step S50.

In this case, in the first bonding step S40, a first edge portion 33c where the outer end portion of the first region A1 is in contact with the outer end portion of the second region A2 in a portion where the first region A1 and the second region A2 are folded and a second edge portion 33d which faces the first edge portion 33c and where the other outer end portion of the first region A1 is in contact with the other outer end portion of the second region A2 are bonded first.

In addition, in the second bonding step S50, the remaining edge portions, which are not bonded in the first bonding step, are bonded to form the first bonded portion 33a together with the first and second edge portions 33c and 33d which are bonded first, and in this case, step S50 may further include a step of forming left and right regions of the intake hole 32a to have a shape of the air filter part 30, which is designed in advance.

As described above, when steps S40 and S50, which are the edge portion bonding processes, are completed, a process of coupling both sides of the air filter part 30 and wearing straps 60 is performed (S60), and in step S60, second bonded portions 33b to which the wearing straps 60 are coupled may be formed at both sides of the air filter part 30 as described in the previous first embodiment.

### Third Embodiment

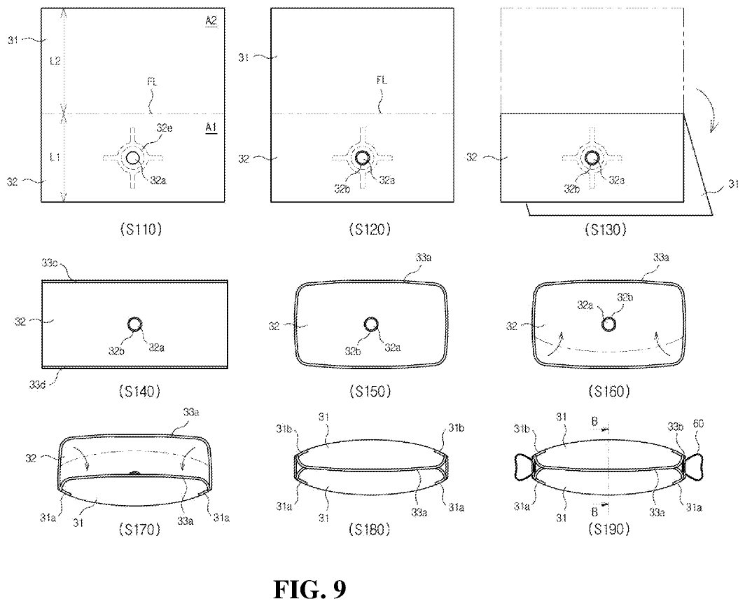

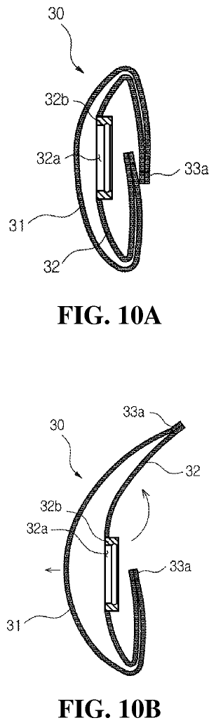

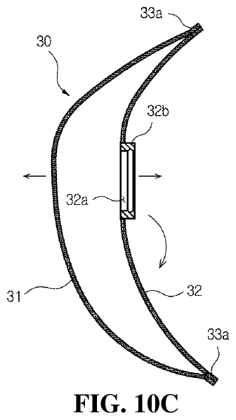

FIGS. 9 and 10 are a set of views for describing a method of manufacturing an air filter part of FIG. 1 according to a third embodiment of the present invention and a set of views for describing a use state, respectively.

Even in the case of the present embodiment, an entire structure of a dustproof mask is the same as that of the first embodiment, but, since there is a difference only in a method of manufacturing an air filter part 30, hereinafter, components that are the same as those of the first embodiment will be denoted by the same reference numerals, and redundant descriptions will be omitted.

In the case of the air filter part 30 manufactured by the above-described method according to the first and second embodiments, since an entire shape thereof is a shape widely extending in upward, downward, leftward, and rightward directions to cover the mask body 10 and a shape in which the first filter member 31 (that is, second region) has the dome shape protruding outward due to the pouch shape of the inner space 35, there is a disadvantage in that a large space for storing or packaging products is required.

Accordingly, a method of manufacturing the air filter part 30 according to the third embodiment or a fourth embodiment of the present invention further includes a process of compactly folding the air filter part 30 formed to have a pouch-shaped inner space 35 therein for easy storing or packaging.

First, since steps S110 to S130 of the method of manufacturing the air filter part according to the third embodiment of the present invention are performed using the same processes in steps S10 to S30 according to the above-described second embodiment, the repeated description thereof will be omitted here.

When step S130 is completed, after a first edge portion 33c and a second edge portion 33d of a first region A1 and a second region A2 are bonded first (S140), the remaining edge portions, which are not bonded in step S140, of left and right sides of an intake hole 32a are bonded to form an overall first bonded portion 33a (S150) as described in steps S40 and S50 of the second embodiment.

When steps S140 and S150 are completed, steps of folding upper end portions and lower end portions of the first and second filter members 31 and 32, of which edge portions are bonded, in directions in which an intake hole 32a formed in the first region (that is, second filter member) is covered thereby are performed (S160, S170, and S180).

In this case, the upper end portions and the lower end portions of the first and second filter members 31 and 32 refer to an upper portion and a lower portion of the intake hole 32a in the drawings, and the upper end portions and the lower end portions are folded in arrow directions along folding lines illustrated as virtual lines in the drawings.

In addition, as an example of the present embodiment, the case in which, after the lower end portions of the first and second filter members 31 and 32 are folded first, the upper end portions thereof are folded thereon has been described, however, after the upper end portions are folded first, the lower end portions may be folded as necessary.

In addition, third bonded portions 31a and 31b may be partially formed on end portions of both sides of portions where the upper end portions and the lower end portions of the first and second filter members 31 and 32 are folded to stably maintain the state in which the upper end portions and the lower end portions are folded, and a method of forming the third bonded portions 31a and 31b is the same as the above-described method of forming the first and second bonded portions 33a and 33b.

In addition, when step S180 is completed, a process of coupling both ends of the air filter part 30 and wearing straps 60 is performed (S190), and in step S190, second bonded portions 33b to which the wearing straps 60 are coupled may be further formed at both sides of the air filter part 30 as described above.

In the case of the air filter part 30 manufactured according to the third embodiment of the present invention, since a user can fold the upper end portions and the lower end portions before coupling the air filter part 30 to a mask body 10 or after separating the air filter part 30 from the mask body 10 as illustrated in FIG. 10A, a vertical length of the intake hole 32a is significantly decreased, and a protruding extent of a first filter member 31 is also decreased, and thus there is an advantage in that storing or packaging is easy.

In addition, in the case in which the air filter part 30 is coupled to the mask body 10, as illustrated in FIGS. 10B and 10C, the folded portions are sequentially unfolded to be used, and in this case, the first filter member 31 protrudes forward and outward (that is, a left direction in the drawing) while the folded portions are unfolded, and the second filter member 32 is pulled in a direction toward a mask body 10 (that is, rightward direction in the drawing)

Accordingly, since the pouch-shaped inner space 35 formed between the first and second filter members 31 and 32 extends normally, the air filter part 30 performs a function of the air filter part 30 described in the first or second embodiment.

### Fourth Embodiment

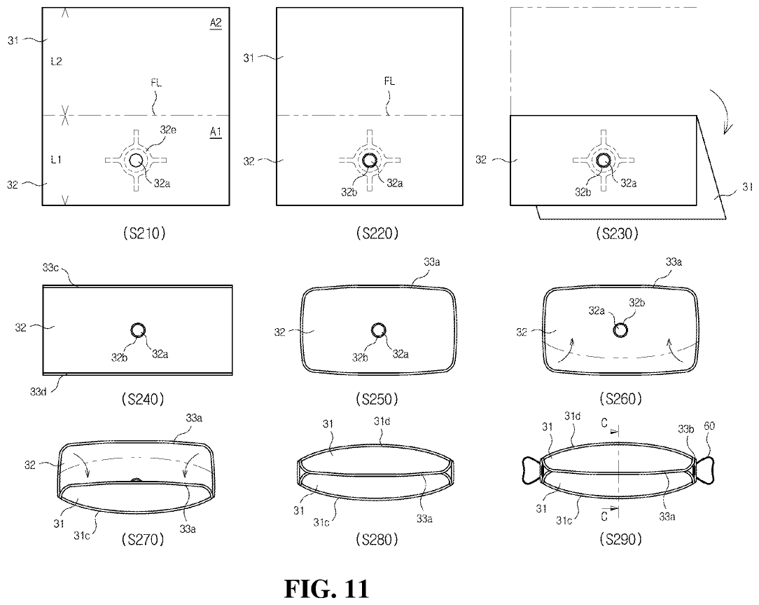

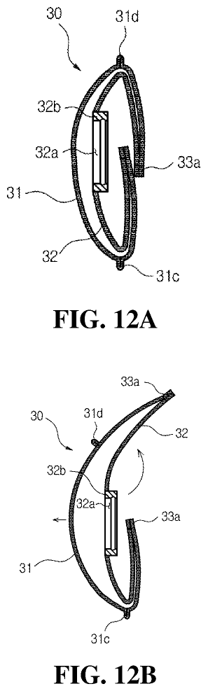

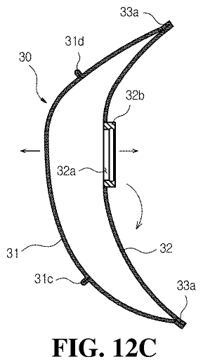

FIGS. 11 and 12 are a set of views for describing a method of manufacturing an air filter part of FIG. 1 according to a fourth embodiment of the present invention, and a set of views for describing a use state, respectively.

Even in the case of the present embodiment, an entire structure of a dustproof mask is the same as that of the first embodiment, but, since there is a difference only in a method of manufacturing an air filter part 30, hereinafter, components that are the same as those of the first embodiment will be denoted by the same reference numerals, and redundant descriptions thereof will be omitted.

The method of manufacturing the air filter part 30 according to the fourth embodiment of the present invention is substantially the same as that of the third embodiment, but there is a slight difference between steps of folding upper end portions and lower end portions of first and second filter members 31 and 32 (S270 and S280)

Accordingly, since steps S210 to S260 are the same as steps S110 to S160 of the third embodiment, respectively, the repeated description thereof will be omitted here.

Meanwhile, when step S260 is completed, in step S270, after the lower end portions of the first and second filter members 31 and 32 are folded, a portion, which is folded, of a second region (that is, first filter member) is cured to form a second support part 31c, and in step S280, after the upper end portions of the first and second filter members 31 and 32 are folded, a portion, which is folded, of the second region (that is, first filter member) is cured to form a second support part 31d.

In this case, in a case in which the upper end portions and the lower end portions of the first and second filter members 31 and 32 are folded, as described above, since lengths of a first region A1 and a second region A2 are different, an end portion having a length, which is relatively greater than a length of an end portion of the first region, of the second region is positioned at a position further outward than the end portion of the first region in the folded portion, and thus only the end portions of the second region A2 may be cured to form the second support parts 31c and 31d.

As described above, in the case in which the folded portion of the second region A2 is cured, and the folded upper end portions and lower end portions of the first and second filter members 31 and 32 are unfolded as illustrated in FIG. 12, since the second support parts 31c and 31d perform functions of lateral ribs, the first filter member 31 is prevented from approaching in a direction (that is, rightward direction) toward the mask body 10, and thus there is an advantage in that a pouch-shaped inner space 35 formed between the first filter member 31 and the second filter member 32 can be more stably maintained.

### Fifth Embodiment

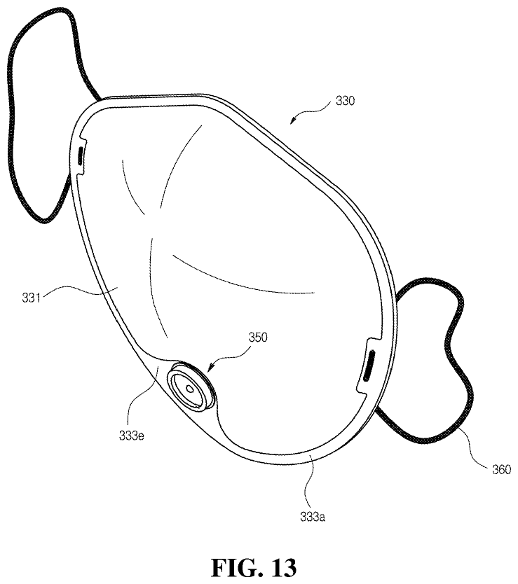

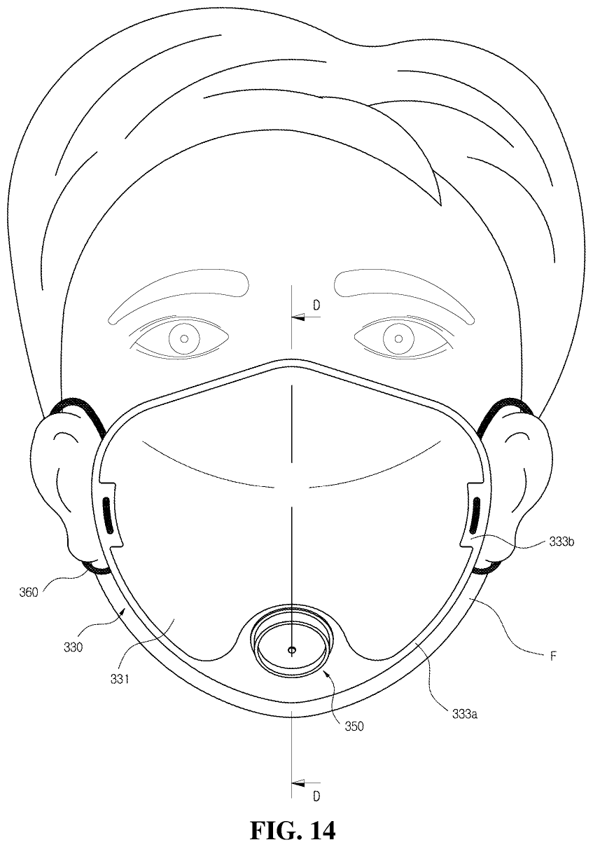

FIG. 13 is a perspective view illustrating a structure of a dustproof mask according to a fifth embodiment of the present invention, and FIG. 14 is a view illustrating a state in which the dustproof mask illustrated in FIG. 13 is worn.

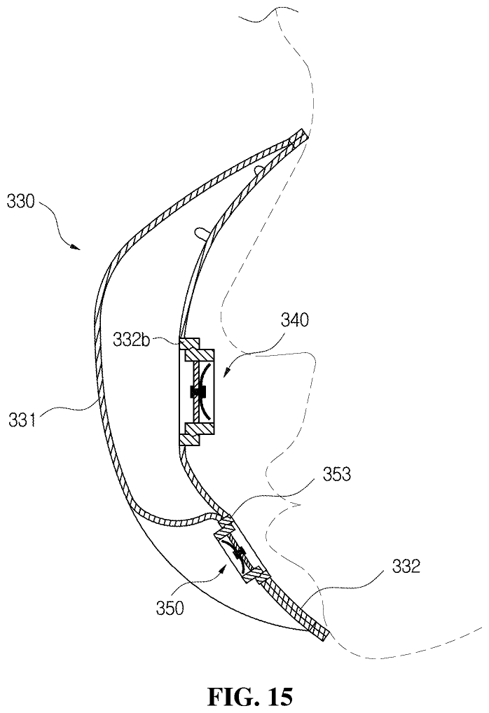

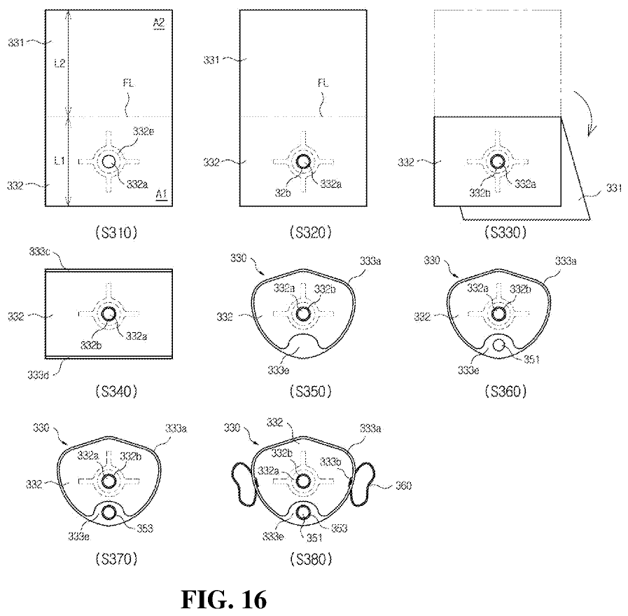

In addition, FIG. 15 is a cross-sectional view taken along line D-D of FIG. 14, and FIG. 16 is a set of views for describing a method of manufacturing the dustproof mask according to the fifth embodiment of the present invention.

In the above-described first to fourth embodiments, the case in which the dustproof mask includes the pouch-shaped air filter part 30 and the mask body 10 has been described, but the air filter part manufactured according the embodiments may also be formed to perform a function of a mask body as is.

The fifth embodiment of the present invention relates to this, and the dustproof mask according to the present embodiment is formed to include a mask body 330 having a sealed pouch shape, and wearing straps 360 coupled to end portions of both sides of the mask body 330.

The method of manufacturing the dustproof mask formed as described above according to the present invention will be described below. First, after preparing filter members 331 and 332 having sheet shapes, an intake hole 332a is formed at one sides of the filter members 331 and 332 (S310).

In this case, the filter members 331 and 332 may be divided as a first region A1 in which the intake hole 332a is formed and a second region A2, which is the remaining portion, by a virtual folding line FL like the above-described second embodiment, and lengths of the first region A1 and the second region A2 may be different.

In addition, like the second embodiment, the second filter member 332 described in the first embodiment is formed in the first region A1 and the first filter member 331 is formed in the second region A2.

In addition, like the second embodiment, step S310 may further include a step of curing a part of an outer side of the intake hole 332a in the first region A1 to form a first support part 332e.

When step S310 is completed, a step of coupling an edge of the intake hole 332a and a ring-shaped member is performed (S320), and the ring-shaped member may be a first coupling member 332b having a tubular shape and protruding outward from the edge of the intake hole 332a like the first and second embodiments.

When step S320 is completed, a step of folding the first region A1 and the second region A2 along the virtual folding line FL is performed so that the first region A1 faces the second region A2 (S330), and in this case, a length L2 of the second region A2 is greater than a length L1 of the first region A1 as described above.

In addition, the first region A1 and the second region A2 folded to face each other in step S330 form the second filter member 332 and the first filter member 331, respectively, as previously described in the first embodiment.

In addition, when step S330 is completed, a step of bonding a first edge portion 333c and a second edge portion 333d of the first region A1 and the second region A2 of a filter member folded to have lengths different from each other through a process which is the same as step S40 of the second embodiment (omitted repeated description) is performed (S340).

Next, the remaining edge portions, which are not bonded in step S340, of left and right sides of the intake hole 332a are bonded to form an entirety of a first bonded portion 333a so that a sealed pouch-shaped mask body 330 is formed (S350).

In addition, in step S350, the first region (that is, second filter member) is bonded to a part of the second region (that is, first filter member) at one lower side of the intake hole 332a to additionally form an exhaust hole region 333e, and in this case, the first bonded portion 333a and the exhaust hole region 333e may be formed through sequential or simultaneous processes.

In addition, step S350 may further include a step of forming left and right regions of the intake hole 332a to have a shape, which is previously designed, of the mask body 330 as described above in the first embodiment.

Thus, when steps S340 and S350 are completed, a process of forming an exhaust hole 351 in the exhaust hole region 333e is performed (S360), and a step of coupling an edge of the exhaust hole 351 and a third coupling member 353 which is a ring-shaped member is performed (S370).

In this case, the third coupling member 353 having the ring shape is a tubular coupling member and is formed to be coupled to an exhaust valve part 350, as will be described below, similar to the first coupling member 332b having the tubular shape and protruding outward from the edge the intake hole 332a as described above.

In addition, a shape or a manufacturing method of the mask body 330 having the pouch shape formed by the first region A1 and the second region A2 through above-described steps is similar to that of the air filter part 30 according to the above-described embodiments but the mask body 330 performs a function of a mask body as is.

Accordingly, the second filter member 332 (that is, first region), in which the intake hole 332a is formed, faces a user's face, and the first filter member 331 (that is, second region) facing the second filter member 332 faces the outside.

In addition, when step S370 is completed, a process of coupling both sides of the mask body 330 and wearing straps 360 is performed (S380), and in step S380, second bonded portions 333b to be coupled to the wearing straps 360 may be further formed at both sides of the mask body 330 as described above.

In addition, although not illustrated in the drawings, in the method of manufacturing the dustproof mask according to the present embodiment, a step of coupling the intake hole 332a and the exhaust hole 351 to an intake valve part 340 and an exhaust valve part 350, respectively, described in the first embodiment may be further performed, wherein structures of the intake valve part 340 and the exhaust valve part 350 are the same as those described in the first embodiment.

In this case, coupling of the first coupling member 332b and the intake valve part 340 is performed by coupling of a coupling groove (not shown) and a coupling protrusion (not shown) formed in the first coupling member 332b and a second coupling member (not shown) formed on the intake valve part 340, respectively, like the above-described first embodiment.

In addition, coupling of the third coupling member 353 and the exhaust valve part 350 is also performed by coupling of a coupling groove (not shown) and a coupling protrusion (not shown) formed on the third coupling member 353 and an exhaust valve housing member (not shown), respectively, like the above-described coupling of the intake valve part 340.

In this case, a process of coupling the intake valve part 340 and the exhaust valve part 350 may be performed after step S370 or S380, and in a case in which the steps are performed, the dustproof mask according to the present invention is manufactured and provided to a user in a state in which the mask body 330 is coupled to the intake valve part 340 and the exhaust valve part 350.

In addition, in the dustproof mask according to the present invention, since the mask body 330 coupled to the wearing straps 360, and the intake valve part 340 and the exhaust valve part 350 are separately provided as necessary, the user may directly couple the mask body 330 to the intake valve part 340 and the exhaust valve part 350 to use the dustproof mask when using the dustproof mask.

In addition, the method of manufacturing the dustproof mask according to the present invention may also further include a process of sequentially folding an upper end portion and a lower end portion of the inhale hole 332a like the third and fourth embodiments as necessary, but, since the process is the same as those of the above-described embodiments, the repeated description thereof will be omitted here.

1. A dustproof mask comprising:
a mask body which is adapted to cover a user's face, and forms a breathing space between an inner surface thereof and the user's face, wherein breathing of a user's respiratory system is performed through the breathing space;
an air filter part disposed in front of the mask body, coupled to one side of an outer surface of the mask body, configured to be filled with external air which passes through an outer surface thereof formed of a filter material and contaminants therein are removed, and having a sealed pouch shape;
an intake valve part installed in a coupled portion of the mask body and the air filter part and operated to supply the air inside the air filter part to the breathing space during inhalation; and
an exhaust valve part installed on the other side of the outer surface of the mask body and operated to discharge air inside the breathing space to the outside during exhalation,
wherein the air filter part is coupled to be spaced apart from the outer surface of the mask body so that an air passage through which external air flows is formed between the air filter part and the mask body.

2. The dustproof mask of claim 1, wherein the air filter part includes:
a first filter member disposed in front of the mask body; and
a second filter member which is disposed between the mask body and the first filter member and of which an edge portion is bonded to the first filter member to form the sealed pouch shape,
wherein the first filter member removes the contaminants contained in external air introduced through the front of the air filter part, and the second filter member removes contaminants contained in external air introduced from the air passage.

3. The dustproof mask of claim 2, wherein:
a first intake hole communicating with an inner space of the air filter part and a first coupling member protruding from an edge of the first intake hole and having a tubular shape are formed in a central portion of the second filter member; and
a second intake hole communicating with the breathing space and a second coupling member protruding from an edge of the second intake hole and having a tubular shape are formed at one side of the outer surface of the mask body,
wherein the air filter part is coupled to the mask body by coupling of the first coupling member and the second coupling member, and
the intake valve part is installed between two ends the first coupling member or the second coupling member.

4. The dustproof mask of claim 3, wherein:
the air filter part is detachably coupled to the mask body by coupling of a coupling groove formed in an inner circumferential surface of the first coupling member and a coupling protrusion formed on an outer circumferential surface of the second coupling member to have a shape corresponding to the coupling groove; and
the intake valve part is formed to include a valve sheet formed between two ends of the second coupling member and having a mesh shape, an intake valve seated on the valve sheet to be opened during inhalation, and a fixing member fixing the intake valve to one side of the valve sheet.

5. The dustproof mask of claim 4, wherein the mask body is an impermeable mask body through which external air is not introduced and includes a plurality of spacers having a rib shape formed to protrude from the outer surface thereof to maintain a separation distance from the air filter part.

6. The dustproof mask of claim 4, further comprising:
a close-contact member coupled to an edge of the mask body; and
wearing straps coupled to end portions of both sides of the air filter part,
wherein, when a user wears the dustproof mask using the wearing straps, the edge of the mask body is brought into close contact with the user's face by the close-contact member, and
an edge of the air filter part is spaced apart from the user's face to maintain the air passage.

7. A method of manufacturing a dustproof mask, comprising:
a) forming an air filter part having a sealed pouch shape;
b) forming a mask body having a dome shape in which an intake hole and an exhaust hole formed in an outer surface thereof are coupled to an intake valve part and an exhaust valve part, respectively; and
c) coupling the air filter part disposed in front of the mask body to the outer surface of the mask body,
wherein the step a) includes:
a1) forming a first filter member having a dome shape;
a2) forming a second filter member in which a through hole is formed in an central portion thereof and which has a dome shape; and
a3) bonding edge portions of the first filter member and the second filter member to form a sealed pouch shape in which a space filled with external air introduced through the first filter member and the second filter member is formed.

8. The method of claim 7, wherein the step c) is performed through a method of coupling a first coupling member protruding from an edge of a through hole formed in the second filter member and having a tubular shape to a second coupling member which protrudes from an edge of the intake hole formed in the mask body and has a tubular shape and in which the intake valve part is installed between two ends thereof,
wherein the air filter part is coupled to be spaced apart from the outer surface of the mask body so that an air passage through which external air flows is formed between the air filter part and the mask body.

9. A method of manufacturing a dustproof mask including a mask body brought into close contact with a user's face and an air filter part detachably coupled to an outer side of the mask body and having a pouch shape, the method comprising:
a) preparing a filter member having a sheet shape;
b) forming an intake hole at one side of the filter member;
c) dividing the filter member into a first region in which the intake hole is formed and a second region which is the remaining region and folding the filter member such that a length of the second region is greater than a length of the first region; and
d) bonding edge portions, where outer end portions of the first region and the second region are in contact with each other, to form a space having a pouch shape therein so that the air filter part is manufactured.

10. The method of claim 9, wherein the step b) further includes a step of coupling a ring-shaped member to an edge of the intake hole.

11. The method of claim 9, wherein:
the step b) further includes a step of curing a part of an outer side of the intake hole in the first region to form a first support part; and
the intake hole is formed in a central portion of the first region.

12. The method of claim 9, wherein the step d) includes:
a first bonding step of bonding a first edge portion in which the outer end portion of the first region is in contact with the outer end portion of the second region in a portion in which the first region and the second region are folded and a second edge portion which faces the first edge portion and where the other outer end portion of the first region is in contact with the other end portion of the second region; and
a second bonding step of bonding the remaining edge portions which are not bonded in the first bonding step.

13. The method of claim 12, further comprising e) folding an upper end portion and a lower end portion of the filter member, of which the edge portions are bonded in the step d), in directions in which the upper end portion and the lower end portion cover the intake hole formed in the first region.

14. The method of claim 13, further comprising f) curing a portion in which the second region is folded in the step e) to form a second support part.

15. A method of manufacturing a dustproof mask, comprising:
a) forming a filter member having a sheet shape;
b) forming an intake hole at one side of the filter member;
c) dividing the filter member into a first region in which the intake hole is formed and a second region which is the remaining region and folding the filter member such that a length of the second region is greater than a length of the first region;
d) bonding edge portions where outer end portions of the first region and the second region are in contact with each other to form a space having a pouch shape therein, and bonding parts of the first region and the second region at one side below the intake hole to form an exhaust hole region; and
e) forming an exhaust hole in the exhaust hole region.

16. The method of claim 15, wherein:
the step b) further includes a step of coupling a first member having a ring shape to an edge of the intake hole; and
the step e) further includes a step of coupling a second member having a ring shape to an edge of the exhaust hole.

17. The method of claim 16, further comprising f) coupling an intake valve part to the intake hole coupled to the first member having the ring shape and coupling an exhaust valve part to the exhaust hole coupled to the second member having the ring shape.

18. A dustproof mask comprising:
a mask body having a sealed pouch shape; and
wearing straps coupled to end portions of both sides of the mask body,
wherein the mask body is manufactured by the method of manufacturing according to claim 15.
